(19) United States
(12) Patent Application Publication
(10) Pub. No.: US 2020/0158131 A1
(43) Pub. Date: May 21, 2020

(54) ROBUST SUPERCHARGER FOR OPPOSED-PISTON ENGINES EQUIPPED WITH EXHAUST GAS RECIRCULATION

(71) Applicant: ACHATES POWER, INC., San Diego, CA (US)

(72) Inventors: JOHN M. KESSLER, San Diego, CA (US); John Koszewnik, Colorado Springs, CO (US); Bryant A. Wagner, San Diego, CA (US)

(73) Assignee: ACHATES POWER, INC., San Diego, CA (US)

(21) Appl. No.: 16/735,526

(22) Filed: Jan. 6, 2020

Related U.S. Application Data
(63) Continuation of application No. PCT/US2018/041643, filed on Jul. 11, 2018.
(60) Provisional application No. 62/538,569, filed on Jul. 28, 2017.

(51) Int. Cl. F04D 29/42; F02C 6/12

(52) U.S. Cl. CPC F04D 29/4206; F02C 6/12; F05D 2300/611; F05D 2300/512; F05D 2220/40

(57) ABSTRACT

A supercharger assembly includes rotors, a base plate, and a housing with an anti-fouling material on one or more surfaces where accumulation of soot and/or soot-like material may lead to mechanical friction and possibly seizing. The anti-fouling material can have oleophobic and/or hydrophobic properties.

### PRIORITY

This application claims priority as a continuation of PCT application PCT/US2018/041643, filed Jul. 11, 2018, and published as WO 2019/022953 A1 on Jan. 31, 2019, which claims priority to U.S. provisional patent application 62/538,569 filed Jul. 28, 2017, titled “Robust Supercharger for Opposed-Piston Engines Equipped with Exhaust Gas Recirculation”.

### CROSS-REFERENCE TO RELATED APPLICATIONS

This application contains subject matter related to that of commonly-owned U.S. provisional patent applications 62/517,521 filed Jun. 9, 2017, titled “Supercharger Protection in an Opposed-Piston Engine With EGR” and 62/517,709, filed Jun. 9, 2017, titled “Supercharger Protection in an Opposed-Piston Engine With EGR.”

### FIELD

The field concerns internal combustion engines. In particular, the field relates to opposed-piston engines which may be applied to vehicles, vessels, and stationary power sources.

### BACKGROUND

A two-stroke cycle engine is an internal combustion engine that completes a cycle of operation with a single complete rotation of a crankshaft and two strokes of a piston connected to the crankshaft. The strokes are typically denoted as compression and power strokes. One example of a two-stroke cycle engine is an opposed-piston engine in which two pistons are disposed in the bore of a cylinder for reciprocating movement in opposing directions along the central axis of the cylinder. Each piston moves between a bottom dead center (BDC) location where it is nearest one end of the cylinder and a top dead center (TDC) location where it is furthest from the one end. The cylinder has ports formed in the cylinder sidewall near respective BDC piston locations. Each of the opposed pistons controls one of the ports, opening the port as it moves to its BDC location, and closing the port as it moves from BDC toward its TDC location. One of the ports serves to admit charge air into the bore, the other provides passage for the products of combustion out of the bore; these are respectively termed “intake” and “exhaust” ports (in some descriptions, intake ports are referred to as “air” ports or “scavenge” ports). In a uniflow-scavenged opposed-piston engine, pressurized charge air enters a cylinder through its intake port as exhaust gas flows out of its exhaust port, thus gas flows through the cylinder in a single direction (“uniflow”) along the length of the cylinder, from intake port to exhaust port.

Charge air and exhaust products flow through the cylinder via an air handling system (also called a “gas exchange” system). Fuel is delivered by injection from a fuel delivery system. As the engine cycles, a control mechanization governs combustion by operating the air handling and fuel delivery systems in response to engine operating conditions. The air handling system may be equipped with an exhaust gas recirculation (“EGR”) system to reduce production of undesirable compounds during combustion.

In an opposed-piston engine, the air handling system moves fresh air into and transports combustion gases (exhaust) out of the engine, which requires pumping work. The pumping work may be done by a gas-turbine driven pump, such as a compressor (e.g., a turbocharger), and/or by a mechanically-driven pump, such as a supercharger. In some instances, the compressor unit of a turbocharger may be located upstream or downstream of a supercharger in a two-stage pumping configuration. The pumping arrangement (single stage, two-stage, or otherwise) drives the scavenging process, which is critical to ensuring effective combustion, increasing the engine's indicated thermal efficiency, and extending the lives of engine components such as pistons, rings, and cylinders.

In configurations that include an exhaust gas low pressure and/or high pressure recirculation (EGR) loop, products of combustion flow into the charge air (intake) channel of the air-handling system wherein pressurized air and recirculated exhaust are mixed before delivery to the cylinders. The products of combustion can include soot and soot-like hydrocarbon particles that can adhere to and foul surfaces of the charge air channel, at times to the extent that moving parts seize and fail. A particular problem in this regard is the build-up of soot and/or soot-like material, possibly with some oil from a crankcase ventilation system and water from condensation mixed with soot, on interior surfaces of the supercharger. The build-up leads to an increase in mechanical friction and can result in eventual scoring and/or seizing of rotors within the supercharger housing. Filters or other cleansing apparatus can be used to remove particles from recirculating exhaust gas. However, filtering and particle removal devices can be costly and can increase the resistance to mass airflow through the engine, reducing the engine's efficiency. Seizing of the supercharger can lead to engine failure.

It is desirable to have a supercharger that is robust and resistant to seizing due to build-up of soot and soot-like particles in an opposed-piston engine with an EGR. In other aspects, it is desirable to reduce the adhesion of soot and soot-like particles to interior surfaces of a supercharger assembly.

### SUMMARY

In some implementations an air handling system for an opposed-piston internal combustion engine includes an exhaust gas recirculation (EGR) system and a supercharger assembly. The supercharger assembly has a bearing plate, a first and a second rotor, and a housing that encloses the first and second rotors. Each of the first and second rotors has two or more lobes, two or more valleys, a bearing plate facing end, and a housing facing end. In the supercharger assembly, the bearing plate includes a coating of anti-fouling material on a surface adjacent to the bearing plate facing ends of the first and second rotors.

In a related aspect, an opposed-piston engine is equipped with a supercharger assembly that includes a bearing plate, a first rotor and a second rotor, and a housing is provided. Each of the first and second rotors has two or more lobes; two or more valleys; a bearing plate facing end; and a housing facing end. The housing, with the bearing plate, encloses the first and second rotors. In the supercharger assembly, the bearing plate includes a coating of anti-fouling material on a surface adjacent to the bearing plate facing ends of the first and second rotors.

The following features can be present in the supercharger assembly and/or in the air handling system in any suitable combination. The housing of the supercharger assembly can have a coating of anti-fouling material on an inside surface. Each of the first and second rotors in the supercharger assembly can have a coating of anti-fouling material on their bearing plate facing end. In the supercharger assembly, the anti-fouling material can include a layer of anodized material impregnated with a material with hydrophobic and oleophobic properties.

In a related aspect, a method of making a supercharger assembly for a uniflow-scavenged, opposed-piston engine includes preparing one or more components of the supercharger assembly for formation of an anti-fouling material thereon, as well as creating an anti-fouling material coating on at least a portion of a surface of the one or more supercharger components.

The following features can be present in the method in any suitable combination. The method can include assembling the one or more components with the anti-fouling material coating with other components of the supercharger assembly to create a complete supercharger assembly. Preparing one or more components of the supercharger assembly for anti-fouling material formation can include polishing, surface roughening, washing with a degreasing agent, etching, machining, or any combination of these methods. The anti-fouling material formed on one or more components of the supercharger assembly can include any of the following, alone or in combination: an anodized metal oxide; polytetrafluoroethylene (PTFE); epoxy, polyurethane or polyamide systems that are reactively cross-linked with perfluorinated monomers or oligomers; a fluoropolymer; an oxidized polyarylene sulfide; a polyphenylene sulfide; carbide; a ceramic material; a high-temperature polyimide; a polyamide imide; a polyester imide; an aromatic polyester plastic; or any material with a low affinity for soot or soot-like compounds and with high dimensional stability when exposed to a large range of temperatures. The anti-fouling material coating can be formed or created on one or more supercharger assembly components by any of vapor deposition, dip coating, thermal oxide growth, selective etching, anodization, electrochemical plating, or electrochemical deposition. The supercharger assembly can include a bearing plate, first and second rotors, and a housing that encloses the first and second rotors. Each rotor includes two or more lobes, two or more valleys, a bearing plate facing end, and a housing facing end. In the supercharger assembly, the anti-fouling material can be formed on at least a portion of one or more components including any of the following: the bearing plate facing end of each rotor, an inner surface of the bearing plate, and an inner surface of the housing.

### BRIEF DESCRIPTION OF THE DRAWINGS

In the figures, FIG. 1 is a schematic diagram of an opposed-piston engine equipped with an air handling system, and is properly labeled “Prior Art.”

FIGS. 2A and 2B show an exemplary supercharger for an opposed-piston engine.

FIG. 3 shows a cross-sectional view of a coated surface of a supercharger component for use with an opposed-piston engine.

FIG. 4 is a method of creating a supercharger for use with an opposed-piston engine with an exhaust gas recirculation system.

### DETAILED DESCRIPTION OF PREFERRED EMBODIMENTS

FIG. 1 is a schematic diagram of an engine system 100 shown with a general example of an opposed-piston engine 110 and, an air handling system of the engine, according to the prior art. The air handling system is in fluid communication with an intake plenum chamber and an exhaust plenum chamber of the engine 110, and includes an air inlet 115, a turbo charger 120 with a compressor 121 and a turbine 122, a first charge air cooler 123, a supercharger 130, a supercharger bypass valve 124, a second charge air cooler 125, a high-pressure exhaust gas recirculation (EGR) valve 126, optionally a pre-turbo catalyst 127, an after-treatment system 128, a back pressure valve 129, and optionally a law-pressure EGR valve 140 and a low-pressure EGR cooler 141. The after-treatment system 128 can include one or more after-treatment devices (e.g., an after-treatment catalyst system, one or more particulate filters).

In instances when the engine 110 is constructed and operated as a two-stroke cycle, opposed-piston engine, gas flow through the engine system 100 is not assisted by any pumping action of the pistons, as occurs in a four-stroke engine with a single piston in each cylinder. Charge air must be continuously pumped to the cylinders by means external to the cylinders. In the engine system 100, such means include the supercharger 130, which is situated downstream of the compressor 121 in the direction of charge air flow. The supercharger 130 maintains a positive pressure drop across the engine 110 that ensures forward motion through the engine of the charge air and exhaust at all engine speeds and loads, a condition that cannot be met by the turbocharger 120. In addition, the supercharger 130 provides needed boost quickly in response to torque demands to which the turbocharger 120 responds more slowly. In many cases, cold start of the engine 110 is enabled by the supercharger 130 pumping air through the charge air system. In instances when the provision of exhaust gas recirculation (EGR) is through a high pressure EGR system such as the EGR loop 131, the supercharger 130 maintains a positive pressure drop across the EGR loop 131 that ensures the transport of exhaust gas through the loop 131. Manifestly, reliable operation of the supercharger 130 is a critical factor in meeting the performance and emission goals of such an engine. Poor, deteriorating, or otherwise impaired supercharger operation must be avoided. However, the integrity of supercharger operation can be severely compromised by build-up of particulates such as soot contained in the recirculated exhaust gas. Generally, when a supercharger is fluidly coupled to an air handling system in which recirculated exhaust is received and mixed with charge air upstream of the supercharger, particulate collection and build-up on internal surfaces pose a threat to the viability of the supercharger.

In the engine system 100 shown in FIG. 1, particulates formed during combustion (e.g., soot, soot-like hydrocarbon particles) may pass through and foul, collect on, or stick to, surfaces in an EGR system and in the air handling system on the charge air delivery side, including the supercharger 130. Surface fouling may increase friction or reduce air flow through some of the air handling system parts. In the supercharger 130, buildup of soot and soot-like materials on the interior of the supercharger's housing and bearing plate, as well as on rotors, can eventually lead to seizing and failure of the supercharger 130. Protection of the supercharger from the effects of particulates is an important objective in engine systems equipped with EGR.

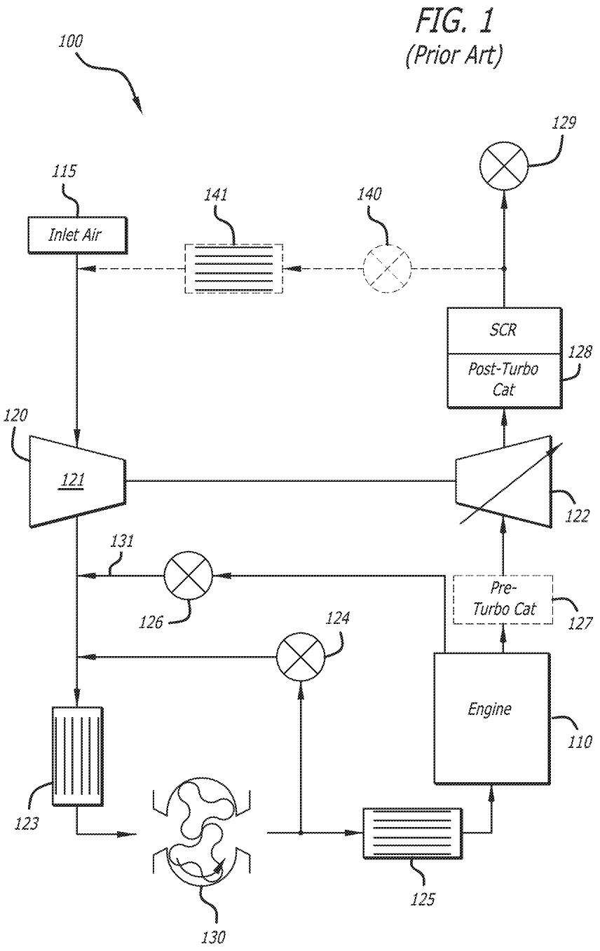

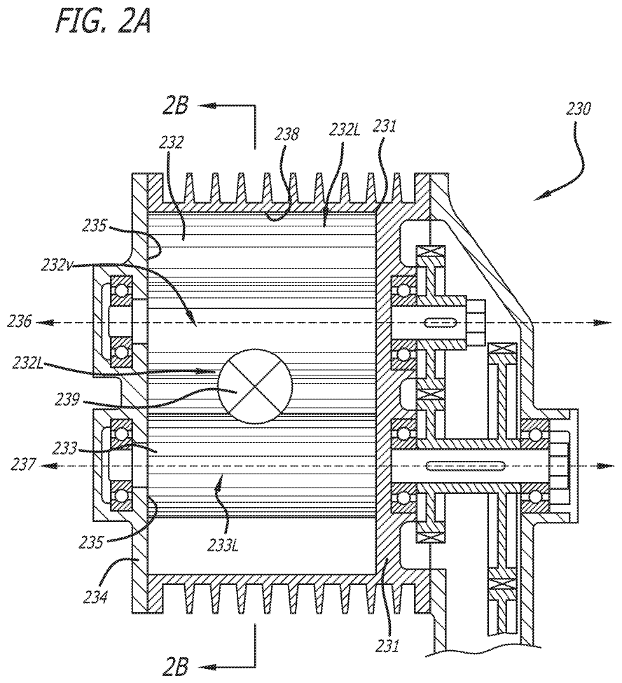

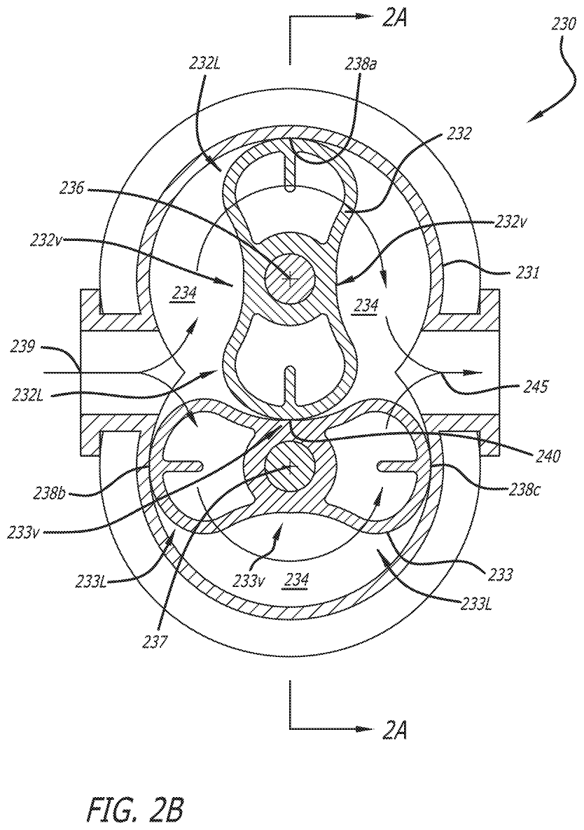

FIGS. 2A and 2B show a supercharger 230 for such an engine. The supercharger is provided with anti-fouling material on one or more component surfaces so that it can be compatible for reliable, long-term use with an EGR system. This supercharger has a particular configuration that is useful for illustrating and explaining principles of coating interior surfaces of a supercharger, with the understanding that the principles are not limited to this configuration alone. Application to other supercharger and/or blower configurations including those with cone-shaped spiraling rotors having two or more lobes is clearly within the scope of these principles. In all events, the supercharger 230 is powered by an engine crankshaft, usually via a drive assembly, not by a turbine spun by exhaust gas as the compressor of a turbocharger would be.

The supercharger 230 includes a housing 231 that, along with a bearing plate 234, encloses a first rotor 232 and a second rotor 233. The first rotor 232 is shown as having two lobes 232L and valleys 232v between the lobes, and similarly, the second rotor 233 has two lobes 233L and valleys 233v between the lobes. The first and second rotors have central axes 236 and 237, respectively, about which the rotors turn. The line 2B in FIG. 2A is the line across which the supercharger is cut in the cross-section to arrive at the view in FIG. 2B.

The flow of charge air through the supercharger is represented as entering the supercharger by 239 in both FIGS. 2A and 2B, and the arrow 245 represents where it leaves the supercharger in FIG. 2B. In FIG. 2A, a rotor/housing interface point 238 is shown. The rotor/housing interface point 238 is where an inner surface of the housing 231 meets with a lobe 232L. In FIG. 2B, multiple rotor/housing interface points 238a, 238b, 238c are shown. In FIG. 2A, rotor./bearing plate interface points 235 are shown, and in FIG. 2B, a rotor/rotor interface 240 is shown. These interface points 238, 235, 240 are locations in which soot-like material can accumulate in a conventional supercharger, eventually causing the rotors in the conventional supercharger to seize.

The anti-fouling material can be a coating or a layered structure created on surfaces of the supercharger assembly, particularly the interfaces described above (e.g., rotor/housing interfaces, rotor/bearing plate interfaces, rotor/rotor interfaces).

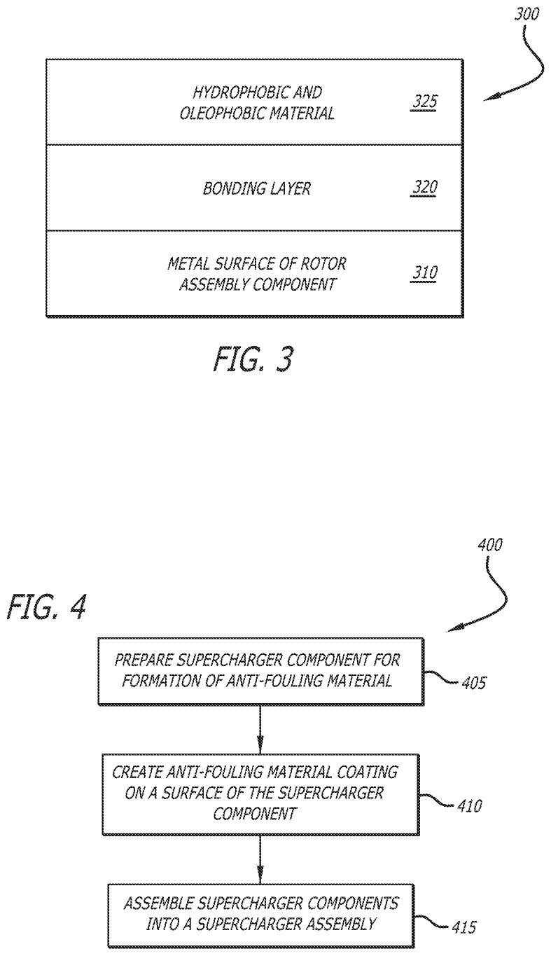

FIG. 3 shows a cross-sectional view 300 of a coated surface of a supercharger component for use with an opposed-piston engine. In the view, the metal surface of a rotor assembly component 310 is shown under an anti-fouling material 325, with bonding layer 320 between the anti-fouling material and component's metal surface. The presence of a bonding layer 320 can depend on the application of materials to form the anti-fouling material 325 on the supercharger component. Described below are various materials and application techniques compatible with the fabrication of a supercharger for an opposed-piston engine with exhaust gas recirculation.

One type of anti-fouling material can be an anodic coating. An anodic coating is produced through the process of anodizing, or reversed electroplating. The metal supercharger component is submerged in an acid electrolyte in an anodizing system that includes a cathode and perhaps another electrode, with the metal part as the anode. Once set up, a current is applied that flows between the cathode and metal component. The water molecules present in the acid electrolyte solution split and release oxygen onto the metal component. The released oxygen converts the surface of the metal component to a metal oxide. The acid in the electrolyte partially dissolves this oxide, creating a porous, or permeable, film on the surface of the component. By varying the time that current is applied and the component is immersed in the acidic electrolyte, the depth of the anodic (e.g., metal oxide) layer and degree of porosity can be varied. This permeable anodic film can trap, or accept, almost all materials that pass through its pores and can be impregnated with many different materials to inhibit adhesion of soot, soot-like materials, and the like. The process of creating an anodized film impregnated with a secondary material to create a hydrophobic and oleophobic material is similar to the processes described in the following standards: MIL-A-63576 and AMS 2482.

Another type of anti-fouling material can be composed of nanoparticles suspended in commercially available polymer matrices such as epoxy, polyurethane or polyamide systems that are reactively cross-linked with perfluorinated monomers or oligomers. Materials with nanoparticles in a polymer matrix can have the desired hydrophobic and oleophobic properties. To apply such a nanoparticle composite material, methods such as spraying, spin coating, dip coating, and the like can be used. The polymer matrix material can be thermally cross-linked (e.g., through critical drying) to achieve the desired crystalline polymorph, or crystal structure. During the thermal cross-linking process, the polymer evaporates and leaves the nanoparticles embedded in the crystalline configuration dictated by the cross-linked matrix.

In addition to, or in place of, the two methods described above, an anti-fouling material with hydrophobic and oleophobic properties can be applied to one or more surfaces of a supercharger assembly using vapor deposition, dip coating, thermal oxide growth, selective etching, anodization, electrochemical plating, electrochemical deposition, or other suitable surface preparation and deposition methods. Suitable anti-fouling materials can include any of a fluoropolymer, an oxidized polyarylene sulfide, a polyphenylene sulfide, carbide, a ceramic material, a high-temperature polyimide, a polyamide imide, a polyester imide, an aromatic polyester plastic, or any material with a low affinity for soot or soot-like compounds and with high dimensional stability when exposed to a large range of temperatures.

Supercharger components can be made of a base metal (e.g., substrate material) of a material suitable for use in superchargers, such as an aluminum alloy. The supercharger components can be prepared before applying an anti-fouling material. Surface preparation of the supercharger components can include polishing, surface roughening, washing with degreasing agent,etching, and machining. Adhesion between the metal of a supercharger component and an anti-fouling material can be increased by the application of heat or a drying cycle (e.g., critical drying, thermal cross-linking, annealing).

FIG. 4 shows a method 400 for creating a supercharger assembly that includes an anti-fouling material. First, supercharger components are prepared for the creation of an anti-fouling material, 405. Preparation can include surface cleaning, etching, surface roughening, machining, and the creation of a bonding layer. The preparation can increase the adhesion of the anti-fouling material to the base metal (e.g., metal surface) of the supercharger component. The component preparation can be followed by creating an anti-fouling material, as layer or coating, on the surface of the supercharger component, 410. In some implementations, only surfaces of supercharger components that are part of interfaces likely to seize due to soot or soot-like adhesions are treated to include anti-fouling material. For example, anti-fouling material can be created on the end of each rotor that faces the bearing plate (e.g., a bearing place facing end) of the assembled supercharger in a supercharger assembly, as well as on the inner surface of the bearing plate in the same supercharger assembly. Once all of the anti-fouling material has been created on the selected supercharger component surfaces, the treated supercharger components can be put together into the complete supercharger assembly, 415.

Once placed into service in an opposed-piston engine with exhaust gas recirculation (EGR), a supercharger assembly as shown in FIG. 2A and 2B can operate as follows. Recirculated exhaust gas or intake air mixed with exhaust gas 239 can enter the supercharger 230 and impinge onto the rotors 232, 233. The rotors 232, 233 rotate to compress the air so that it exits the supercharger 230 through an outlet 245 at a higher pressure. As the rotors compress the air, soot or soot-like particles from the recirculated exhaust gas can contact surfaces of the supercharger components. The surfaces on the interior of the supercharger 230 that include anti-fouling material can be the bearing plate 234 and/or the portions of the interior of the housing 231 that could be part of rotor/housing interface points 238a, 238b, 238c. Soot or soot-like particles can adhere less on these parts that do include anti-fouling material, so that the supercharger does not experience build-up of soot on its interior. This will prevent the supercharger from seizing. The surfaces in the supercharger assembly that include anti-fouling material can be adjacent to surfaces that are abradable (e.g., have an abradable coating, include graphite) to ensure tight clearances between the rotors, as well as between the rotors and housing.

Those skilled in the art will appreciate that the specific embodiments set forth in this specification are merely illustrative and that various modifications are possible and may be made therein without departing from the scope of an invention which is defined by the following claims.

What is claimed is:

1. A supercharger assembly, comprising:
a bearing plate;
a first rotor and a second rotor, each rotor comprising:
two or more lobes;
two or more valleys;
a bearing plate facing end; and
a housing facing end; and
a housing that, with the bearing plate, encloses the first and second rotors,
wherein the bearing plate includes anti-fouling material on a surface adjacent to the bearing plate facing ends of the first and second rotors.

2. The supercharger assembly of claim 1, wherein the housing comprises the anti-fouling material on an inside surface.

3. The supercharger assembly of claim 1, wherein each of the first and second rotors comprises the anti-fouling material on the bearing plate facing end.

4. The supercharger assembly of claim 1, wherein the anti-fouling material comprises a layer of anodized material impregnated with a material with hydrophobic and oleophobic properties.

5. An air handling system of a two-stroke, internal combustion engine, comprising:
an exhaust gas recirculation (EGR) system; and
a supercharger assembly coupled to receive recirculated exhaust from the EGR system,
the supercharger assembly comprising:
a bearing plate;
a first rotor and a second rotor;
each rotor comprising two or more lobes; two or more valleys; a bearing plate facing end; and, a housing facing end; and,
a housing that, with the bearing plate, encloses the first and second rotors;
wherein the bearing plate includes anti-fouling material on a surface adjacent to the bearing plate facing ends of the first and second rotors.

6. A method of making a supercharger assembly, comprising:
preparing one or more components of the supercharger assembly for formation of an anti-fouling material; and
forming an anti-fouling material coating on at least a portion of a surface of the one or mare components.

7. The method of claim 6, further comprising assembling the one or more components with the anti-fouling material coating with other components of the supercharger assembly to create a complete supercharger assembly.

8. The method of claim 6, wherein preparing one or more components of the supercharger assembly for anti-fouling material formation comprises at least one of polishing, surface roughening, washing with degreasing agent, etching, and machining.

9. The method of claim 6, wherein the anti-fouling material comprises at least one of: an anodized metal oxide; polytetrafluoroethylene (PTFE); epoxy, polyurethane or polyamide systems that are reactively cross-linked with perfluorinated monomers or oligomers; a fluoropolymer; an oxidized polyarylene sulfide; a polyphenylene sulfide; carbide; a ceramic material; a high-temperature polyimide; a polyamide imide; a polyester imide; an aromatic polyester plastic; or any material with a low affinity for soot or soot-like compounds and with high dimensional stability when exposed to a large range of temperatures.

10. The method of claim 6, wherein the anti-fouling material coating is created by any vapor deposition, dip coating, thermal oxide growth, selective etching, anodizatien, electrochemical plating, or electrochemical deposition.

11. The method of claim 6, wherein the supercharger assembly comprises:
a bearing plate:
a first rotor and a second rotor, each rotor comprising two or more lobes; two or more valleys; a bearing plate facing end; and a housing facing end; and,
a housing that, with the bearing plate, encloses the first and second rotors,
wherein the one or more components of the supercharger assembly on which the anti-fouling material are formed comprise any of the bearing plate facing end of each rotor, at least a portion of an inner surface of the bearing plate, and at least a portion of an inner surface of the housing.

12. An air handling system of a two-stroke, opposed-piston engine, comprising:
a supercharger in which recirculated exhaust gas is received and mixed with charge air upstream of the supercharger;
the supercharger comprising:
a bearing plate;
a first rotor and a second rotor, each rotor comprising two or more lobes, two or more valleys: a bearing plate facing end; and,
a housing facing end;
a housing that, with the bearing plate, encloses the first and second rotors; and, an anti-fouling material on a surface of the bearing plate adjacent to the bearing plate and facing ends of the first and second rotors.

13. The supercharger of claim 12, wherein the housing comprises the anti-fouling material on an inside surface.

14. The supercharger of claim 12, wherein each of the first and second rotors comprises the anti-fouling material on the bearing plate facing end.

15. The supercharger of claim 12, wherein the anti-fouling material comprises a layer of anodized material impregnated with a material with hydrophobic and oleophobic properties.

16. The supercharger of any one of claims 13, 14, and 15 wherein the anti-fouling material comprises at least one of: an anodized metal oxide; polytetrafluoroethylene (PTFE); epoxy, polyurethane or polyamide systems that are reactively cross-linked with perfluorinated monomers or oligomers; a fluoropolymer; an oxidized polyarylene sulfide; a polyphenylene sulfide; carbide; a ceramic material; a high-temperature polyimide; a polyamide imide; a polyester imide; an aromatic polyester plastic; or any material with a low affinity for soot or soot-like compounds and with high dimensional stability when exposed to a large range of temperatures.
